(19) United States
(12) Patent Application Publication
(10) Pub. No.: US 2025/0379759 A1
(43) Pub. Date: Dec. 11, 2025

(54) SPECIALIZED CHARGING FUNCTION (CHF) ROLES FOR DIFFERING TRAFFIC CLASSES

(71) Applicant: T-Mobile USA, Inc., Bellevue, WA (US)

(72) Inventors: Murugappan PALANIAPPAN, Issaquah, WA (US); Nitin BHAKRI, Sammamish, WA (US)

(21) Appl. No.: 18/739,271

(22) Filed: Jun. 10, 2024

(51) Int. Cl. H04L 12/14; H04L 47/20; H04L 47/2441

(52) U.S. Cl. CPC H04L 12/1407; H04L 47/20; H04L 47/2441

(57) ABSTRACT

Solutions are disclosed that provide failure handling for specialized charging function (CHF) roles for differing traffic classes. A network bridge sits between a session management node, such as a session management function (SMF), and a charging node, such as a CHF, routing data traffic to/from the specialized charging node that each caters to a different traffic class or traffic segment, and acting as a proxy in each direction. The session management node sees the network bridge as a single charging node, and thus requires no new functionality to steer traffic to a specific specialized charging node. Each charging node sees the network bridge as a session management node, and thus also requires no new functionality. Each of the session management node and the specialized charging nodes is able to maintain legacy operation, leaving the routing of the differing traffic classes to the specialized charging nodes up the network bridge.

### BACKGROUND

In at least fifth generation (5G) cellular networks, a session management node, such as a session management function (SMF), sends a request to a charging node, such as a charging function (CHF) to charge for a data traffic session for a user equipment (UE), and also to stop a session, such as for troubleshooting purposes. There are different classes of data traffic sessions, with differing policies, and charging rules. However, in Third Generation Partnership Project (3GPP) technical standards (TSs), a session management function operates with only a single charging node, which acts as a barrier to using specialized charging nodes that each caters to a different traffic class or traffic segment.

### SUMMARY

The following summary is provided to illustrate examples disclosed herein, but is not meant to limit all examples to any particular configuration or sequence of operations.

Solutions are disclosed that provide specialized charging function (CHF) roles for differing traffic classes. Examples receive, by a first network bridge, from a first session management node of a wireless network, first data traffic; determine that the first data traffic is associated with a first traffic class; embed an address of the first session management node in the first data traffic; based on at least the first data traffic being associated with the first traffic class, forward the first data traffic to both a first charging node and a second charging node; receive, by the first network bridge, from a second session management node of the wireless network, second data traffic; determine that the second data traffic is associated with a second traffic class; embed an address of the second session management node in the second data traffic; and based on at least the second data traffic being associated with the second traffic class, forward the second data traffic to the second charging node but not to the first charging node, wherein the first charging node is operative to charge for and enforce traffic policies for the first traffic class, and wherein the second charging node is operative to charge for and enforce traffic policies for the second traffic class and to perform traffic diagnostics for both the first traffic class and the second traffic class.

### BRIEF DESCRIPTION OF THE DRAWINGS

The disclosed examples are described below with reference to the accompanying drawing figures listed below, wherein:

FIG. 1 illustrates an exemplary architecture that advantageously provides specialized charging function (CHF) roles for differing traffic classes;

FIG. 2 illustrates further detail for the example architecture of FIG. 1;

FIG. 3 is a flowchart of operations associated with providing specialized CHF roles, as may be performed by examples of the architecture of FIG. 1;

FIGS. 4A, 4B, 4C, and 4D illustrate exemplary message sequence diagrams of messages that may occur when performing the operations of FIG. 3;

FIG. 5 shows detail for an exemplary message of the message sequence diagram of FIG. 4A;

FIG. 6 is another flowchart of operations associated with providing specialized CHF roles, as may be performed by examples of the architecture of FIG. 1;

FIG. 7 illustrates an exemplary message sequence diagram of messages that may occur when performing the operations of FIG. 6;

FIG. 8 shows detail for an exemplary message of the message sequence diagram of FIG. 7;

FIGS. 9 and 10 illustrate additional flowcharts of exemplary operations associated with the architecture of FIG. 1; and

FIG. 11 illustrates a block diagram of a computing device suitable for implementing various aspects of the disclosure.

Corresponding reference characters indicate corresponding parts throughout the drawings. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that provide failure handling for specialized charging function (CHF) roles for differing traffic classes. A network bridge sits between a session management node, such as a session management function (SMF), and a charging node, such as a CHF, routing data traffic to/from the specialized charging node that each caters to a different traffic class or traffic segment, and acting as a proxy in each direction. The session management node sees the network bridge as a single charging node, and thus requires no new functionality to steer traffic to a specific specialized charging node. Each charging node sees the network bridge as a session management node, and thus also requires no new functionality. Each of the session management node and the specialized charging nodes is able to maintain legacy operation, leaving the routing of the differing traffic classes to the specialized charging nodes up the network bridge.

Aspects of the disclosure improve the performance of cellular networks by increasing network efficiency. Specialized charging function roles for differing traffic classes, each performed by a specific type of customized charging node are now possible, without perturbing the legacy operation of session management nodes. These advantageous results are accomplished, at least in part, by embedding an address of the first session management node in data traffic and, based on at least the data traffic being associated with a first traffic class, forwarding the data traffic to both a first charging node and a second charging node or, based on at least the data traffic being associated with a second traffic class, forwarding the data traffic to the second charging node but not to the first charging node.

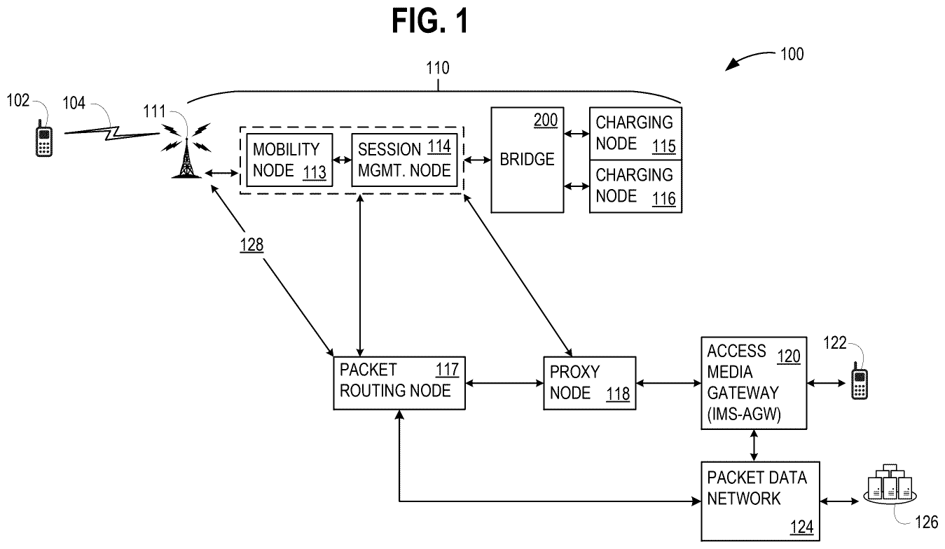

With reference now to the figures, FIG. 1 illustrates an exemplary architecture 100 that advantageously provides specialized charging function roles for differing traffic classes in a wireless network 110 that is illustrated as serving a UE 102. UE 102 may be an enhanced Mobile Broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network. In the scene depicted in FIG. 1, UE 102 is using wireless network 110 for a packet data session to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone (SA) 5G, which is a full 5G implementation that does not rely on 4G technology for some functionality, may be referred to SA NR.

UE 102 uses an air interface 104 to communicate with a base station 111 of wireless network 110, such that base station 111 is the serving base station for UE 102 (providing the serving cell). In some scenarios, base station 111 may be referred to as a radio access network (RAN). Wireless network 110 has a mobility node 113, a session management node 114, two specialized charging nodes (a charging node 115 and a charging node 116), and other components (not shown). Wireless network 110 also has a packet routing node 117 and a proxy node 118. Mobility node 113, session management node 114, and charging nodes 115 and 116 are within a control plane of wireless network 110, and packet routing node 117 is within a data plane (a.k.a. user plane) of wireless network 110.

Base station 111 is in communication with mobility node 113 and packet routing node 117. Mobility node 113 is in communication with session management node 114, which is in communication with charging node 115, charging node 115, packet routing node 117, and proxy node 118. Packet routing node 117 is in communication with proxy node 118 and packet data network 124.

In some 5G examples, base station 111 comprises a gNodeB (gNB), mobility node 113 comprises an access mobility function (AMF), session management node 114 comprises a session management function (SMF), each of charging nodes 115 and 116 comprises a charging function (CHF), and packet routing node 117 comprises a user plane function (UPF). In some 4G examples, base station 111 comprises an eNodeB (eNB), mobility node 113 comprises a mobility management entity (MME), session management node 114 comprises a system architecture evolution gateway (SAEGW) control plane (SAEGW-C), each of charging nodes 115 and 116 comprises an online charging system (OCS), and packet routing node 117 comprises an SAEGW-user plane (SAEGW-U). In some examples, proxy node 118 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site, and may be a mix of 5G and 4G.

Proxy node 118 is in communication with an internet protocol (IP) multimedia system (IMS) access gateway (IMS-AGW) 120 within an IMS, in order to provide connectivity to other wireless (cellular) networks, such as for a call with a UE 122 or a public switched telephone system (PSTN, also known as plain old telephone system, POTS). In some examples, proxy node 118 may be considered to be within the IMS. UE 102 reaches network resource 126 using packet data network 124 (or the IMS, in some examples). Data packets of data traffic 128 to/from UE 102 pass through at least base station 111 and packet routing node 117 on their way from/to packet data network 124 or IMS-AGW 120 (via proxy node 118).

As described more fully below, in relation to the other figures, charging nodes 115 and 116 each caters to a different class of data traffic. For example, charging node 115 handles charging and policy enforcement for a first traffic class, such as a business to consumer (B2C) traffic class. Charging node 116 handles charging and policy enforcement for a second traffic class, such as a business to business (B2B) traffic class, as well as troubleshooting for both B2C and B2B traffic classes. In this example, charging node 115 may be considered to be a B2C charging node and charging node 116 may be considered to be a B2B charging node. Other different traffic segmentations may be used in some examples.

A network bridge 200 sits between session management node 114 on one side and charging nodes 115 and 116 on the other side. Session management node 114 may continue its legacy operation with respect to communicating with a charging node (i.e., without splitting data traffic), but instead of communicating with an actual charging node, communicates with network bridge 200 instead. Network bridge 200 splits and recombines data traffic to/from charging nodes 115 and 116. Similarly, charging nodes 115 and 116 may continue their legacy operation with respect to communicating with a session management node, but instead of communicating with an actual session management node, each of charging nodes 115 and 116 communicates with network bridge 200 instead. This network bridge concept that segments data traffic, while preserving legacy operation of other nodes, may be extended to other functions beyond charging.

Although FIG. 1 and some of the following figures are described using an example of a cellular network, it should be understood that the teachings herein are applicable to other types of wireless networks. To benefit from the teachings herein, another type of wireless network should have nodes with specialized functionality, and different classes of data traffic that can be segmented for operation by specialized network nodes. With such features, another type of wireless network, other than a cellular network, may also benefit from the disclosure herein.

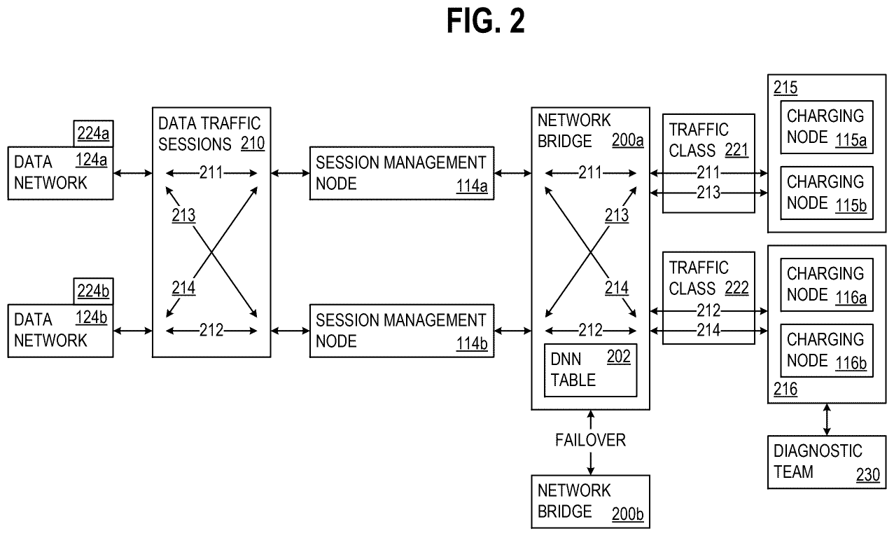

FIG. 2 illustrates further detail for the setting of architecture 100 in which examples of network bridge 200, charging node 115, and charging node 116 operate. A network bridge 200a and a network bridge 200a are each examples of network bridge 200; a charging node 115a and a charging node 115b are each examples of charging node 115; a charging node 116a and a charging node 115b are each examples of charging node 116; and a session management node 114a and a session management node 114b are each examples of session management node 114.

Multiple data networks send and receive data across a set of data traffic sessions 210 to session management nodes of wireless network 110. For example, a first data network 124a, with a data network name (DNN) 224a sends data traffic 211 to session management node 114a and data traffic 213 to session management node 114b. A second data network 124b, with a DNN 224b sends data traffic 212 to session management node 114b and data traffic 214 to session management node 114a.

Session management node 114a sends data traffic 211 and data traffic 214 to network bridge 200a, and session management node 114b sends data traffic 212 and data traffic 213 to network bridge 200a. Network bridge 200a has a DNN table 202 that associates originating data networks with different traffic classes (e.g., B2C versus B2B). Using DNN table 202, network bridge 200a identifies that data traffic 211 and data traffic 213 are associated with a first traffic class 221 (e.g., B2C), because data traffic 211 and data traffic 213 each contain DNN 224a of the originating data network 124a. Similarly, network bridge 200a identifies that data traffic 212 and data traffic 214 are associated with a second traffic class 222 (e.g., B2B), because data traffic 212 and data traffic 214 each contain DNN 224b of the originating data network 124b. That is, data traffic from data network 124a is considered to be of traffic class 221 and data traffic from data network 124b is considered to be of traffic class 222.

A plurality of charging nodes 215, which includes charging node 115a and charging node 115b provides charging nodes that are operative to process traffic class 221, such as charging for and applying policies (e.g., throttling) to traffic class 221. The various charging nodes of plurality of charging nodes 215 may operate interchangeably for load balancing and failover. For example, charging node 115b has the functionality described herein for charging node 115a. Similarly, a plurality of charging nodes 216, which includes charging node 116a and charging node 116b provides charging nodes that are operative to process traffic class 222, such as charging for and applying policies (e.g., throttling) to traffic class 222. However, plurality of charging nodes 216 also is operative to perform troubleshooting for both traffic class 221 and traffic class 222. The various charging nodes of plurality of charging nodes 216 may operate interchangeably for load balancing and failover. For example, charging node 116b has the functionality described herein for charging node 116a.

A network bridge 200b provides a failover for network bridge 200a, and so is similarly configured, also having the functionality described herein for network bridge 200a. A diagnostic team 230 accesses the charging nodes of plurality of charging nodes 216 in order to perform troubleshooting on data traffic of both traffic class 221 and traffic class 222, such as triggering terminate action requests that terminate certain ones of data traffic sessions 210.

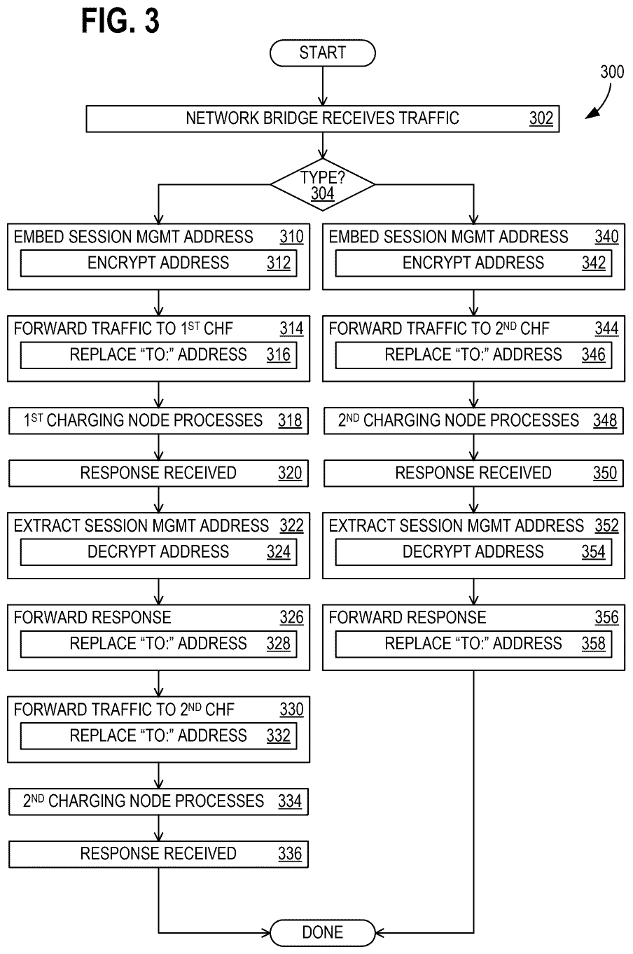

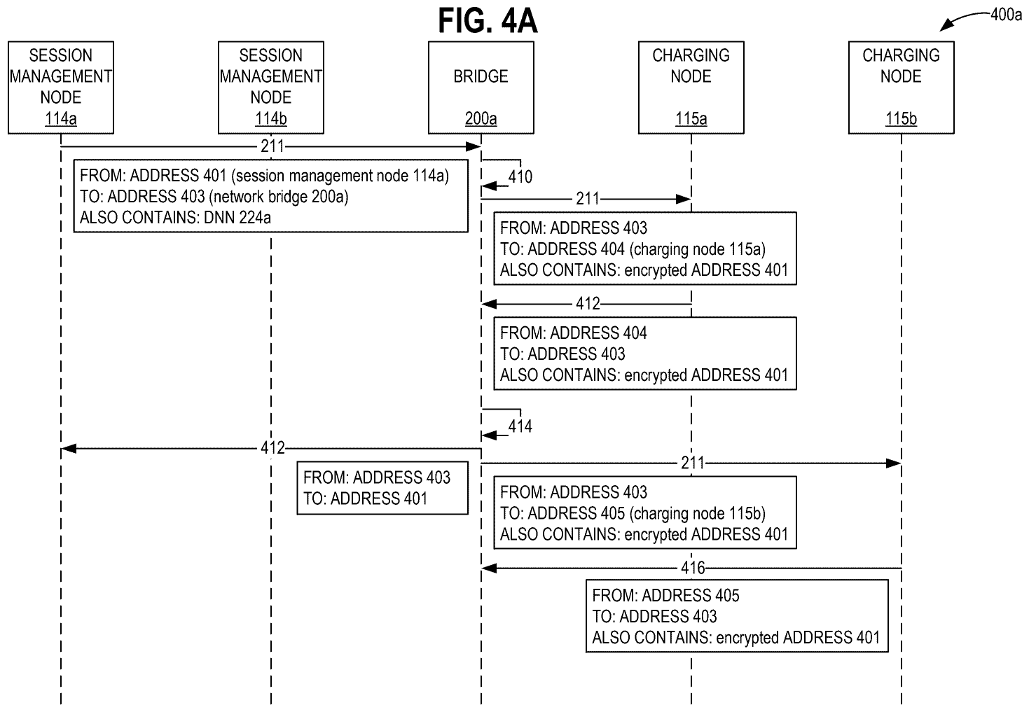

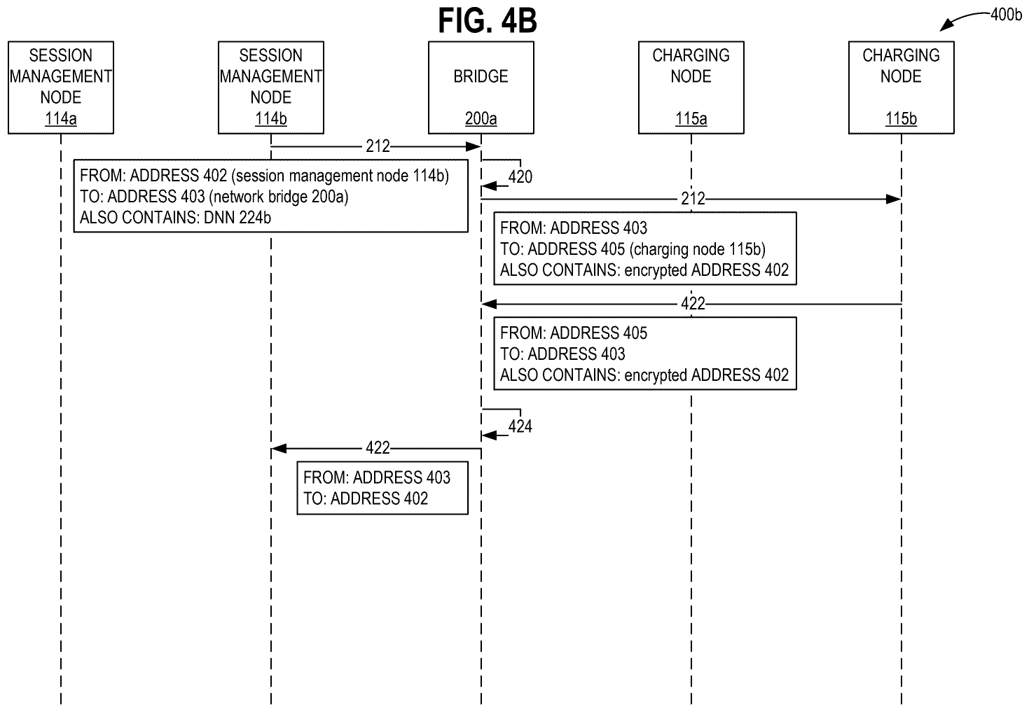

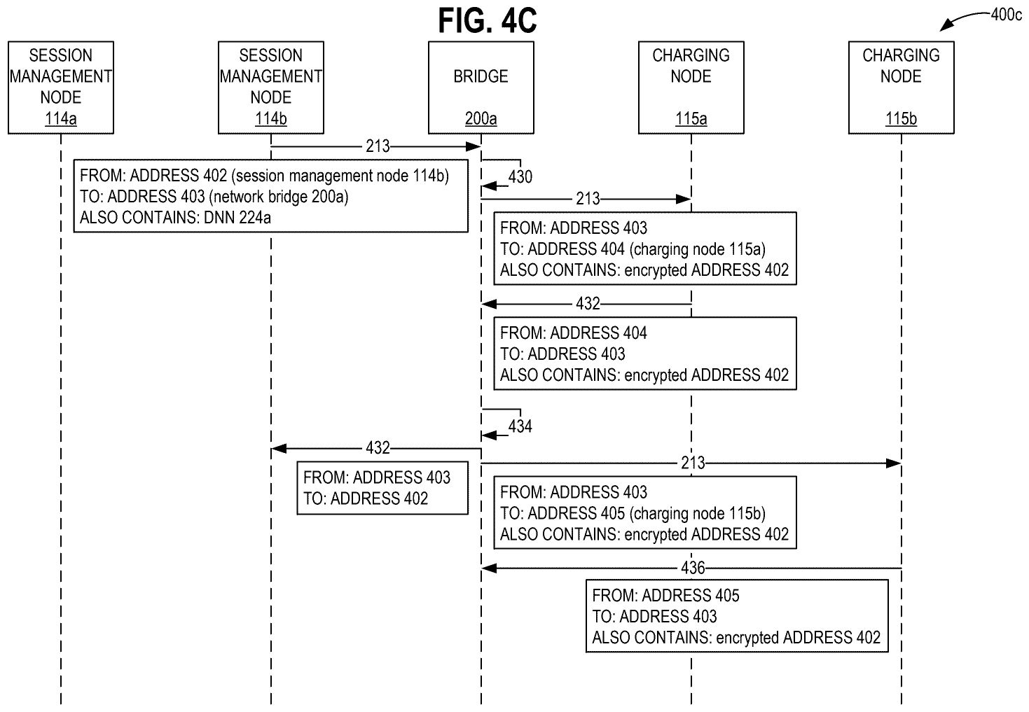

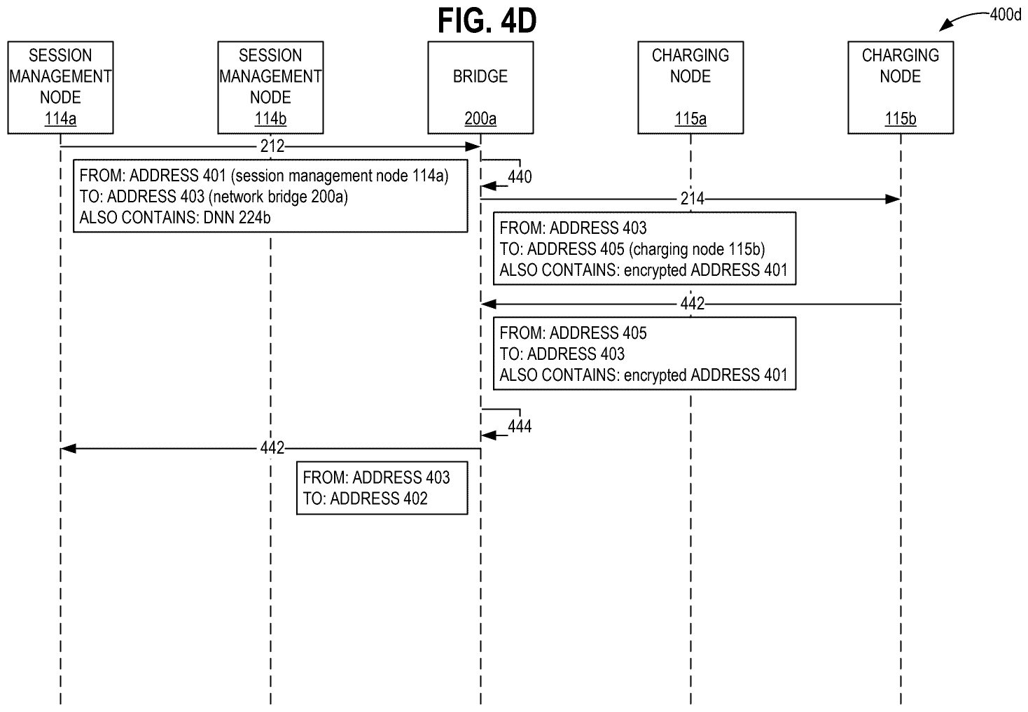

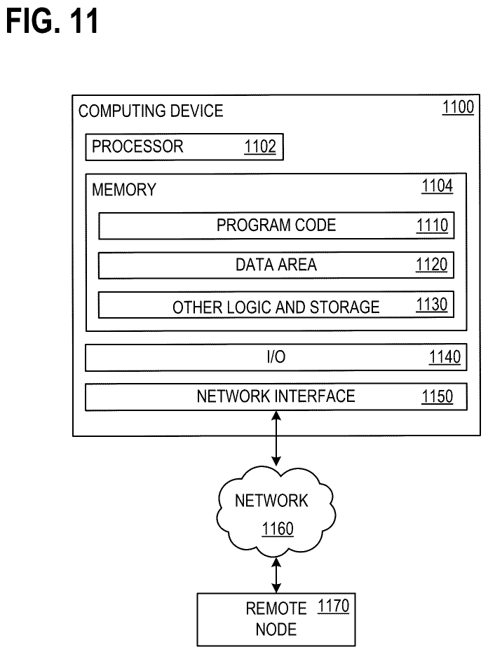

FIG. 3 illustrates a flowchart 300 of exemplary operations associated with providing specialized charging roles in architecture 100. In some examples, at least a portion of flowchart 300 may be performed using one or more computing devices 1100 of FIG. 11. FIGS. 4A, 4B, 4C, and 4D illustrate exemplary message sequence diagrams 400a, 400b, 400c, and 400d, respectively, of messages that may occur during various passes through flowchart 300. As such, FIG. 3 is described along with each of FIGS. 4A, 4B, 4C, and 4D, in turn.

This first described pass through flowchart 300 commences with network bridge 200a receiving data traffic 211 from session management node 114a in operation 302. Decision operation 304 determines whether the data traffic received in operation 302 is associated with traffic class 221 or traffic class 222. In some examples, decision operation 304 uses DNN table 202 and the DNN from which the data traffic was received.

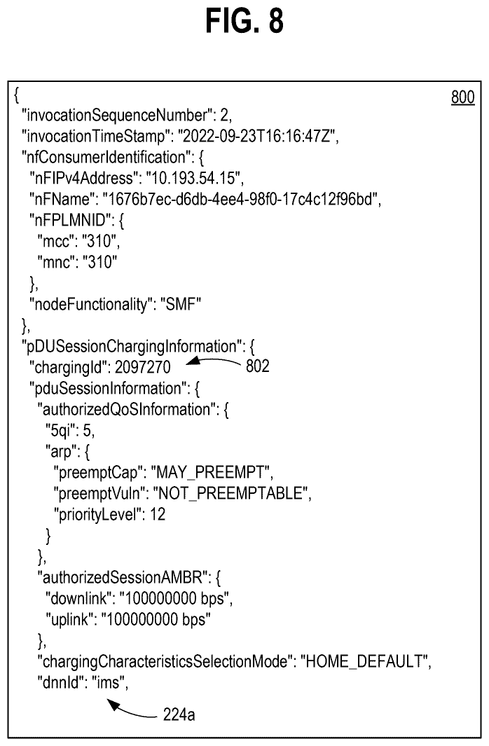

In this first pass through flowchart 300, decision operation 304 determines that data traffic 211 is associated with traffic class 221, because data traffic 211 is associated with DNN 224a (i.e., contains DNN 224a, an example of which is shown in FIG. 8 for another type of message). This branch and pass through flowchart 300 is associated with message sequence diagram 400a. Data traffic 211 is shown in message sequence diagram 400a of FIG. 4A as going from session management node 114a to network bridge 200a, and so has a packet header “from” field populated with an address 401 of session management node 114a, a “to” field populated with an address 403 of network bridge 200a, and DNN 224a somewhere within the content of data traffic 211.

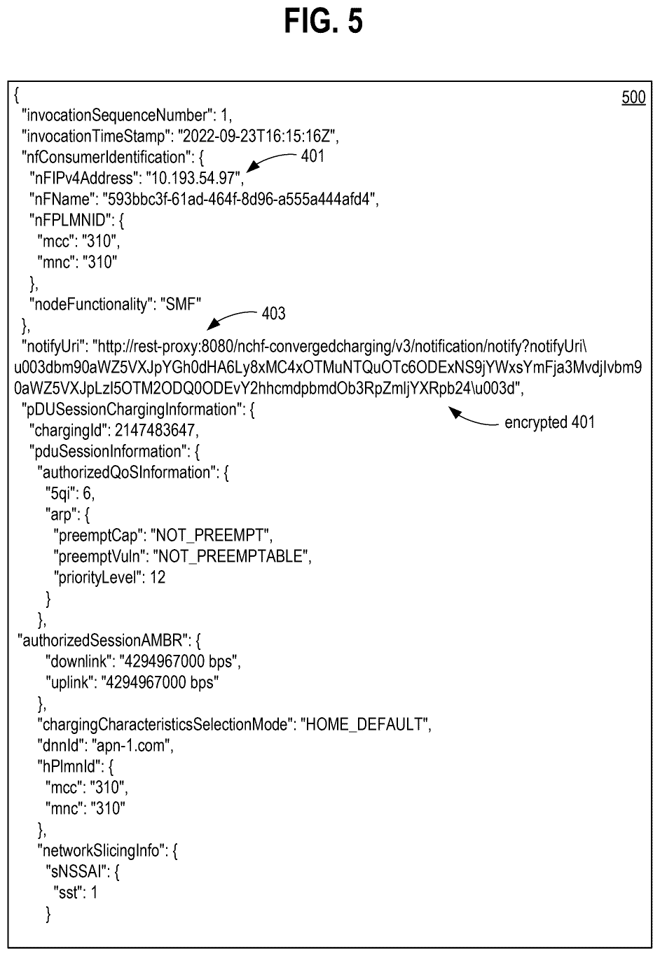

In operation 310 of flowchart 300 (of FIG. 3), also shown as operation 410 in message sequence diagram 400a (of FIG. 4A), network bridge 200a embeds address 401 of session management node 114a in data traffic 211. In some examples, the embedded address 401 is encrypted by operation 312. An example of this is shown in FIG. 5. Turning briefly to FIG. 5, an example message 500 shows a source internet protocol (IP) address, shown as address 401 of session management node 114a, and also has a notification URI including address 403 of network bridge 200a, followed by an encrypted version of address 401.

Returning to FIGS. 3 and 4A, network bridge 200a forwards data traffic 211 to charging node 115a in operation 314 (based on at least data traffic 211 being associated with traffic class 221), by replacing the “to” address, originally address 403 of network bridge 200a, with address 404 of charging node 115a in data traffic 211, in operation 316. Additionally, the “from” address is replaced with address 403 of network bridge 200a, along with the encrypted version of address 401 (as described above). Charging node 115a processes data traffic 211 in operation 318, such as charging for and enforcing traffic policies for data traffic 211. Enforcing traffic policies may include throttling or capping traffic flow.

Charging node 115a responds to data traffic 211 with a response 412, which is received by network bridge 200a in operation 320. Response 412 is from address 404 and to address 403, along with the encrypted version of address 401. In operation 322, network bridge 200a extracts address 401 from response 412, which includes decrypting address 401 in operation 324. This is also shown as operation 414 in message sequence diagram 400a.

Network bridge 200a forwards response 412 to session management node 114a using the (decrypted) extracted address 401 in operation 326, which includes replacing address 403 with address 401 in response 412, during operation 328. Additionally, the “from” address is changed from address 404 to address 403. In operation 330, network bridge 200a also forwards data traffic 211 to charging node 115b (for possible troubleshooting purposes), based on at least receiving response 412, in operation 332. This requires replacing address 403 with address 405 of charging node 115b in the version of data traffic 211 that was received from session management node 114a. An equivalent operation is replacing address 404 with address 405 in the version of data traffic 211 that was forwarded to charging node 115a.

In operation 334, charging node 115b processes data traffic 211, such as performing traffic diagnostics for data traffic 211. Charging node 115b responds to data traffic 211 with a response 416, which is received by network bridge 200a in operation 336. However, because session management node 114a is operating in a legacy manner and is expecting to be communicating with only a single charging node, response 416 is not forwarded to session management node 114a. Session management node 114a already received response 412.

The next described pass through flowchart 300 commences with network bridge 200a receiving data traffic 212 from session management node 114b in operation 302. In this pass through flowchart 300, decision operation 304 determines that data traffic 212 is associated with traffic class 222, because data traffic 212 is associated with DNN 224b (i.e., contains DNN 224b). This branch and pass through flowchart 300 is associated with message sequence diagram 400b. Data traffic 212 is shown in message sequence diagram 400b of FIG. 4B as going from session management node 114b to network bridge 200a, and so has a packet header “from” field populated with an address 402 of session management node 114b, a “to” field populated with an address 403 of network bridge 200a, and DNN 224b somewhere within the content of data traffic 212.

In operation 340 of flowchart 300 (of FIG. 3), also shown as operation 420 in message sequence diagram 400b (of FIG. 4B), network bridge 200a embeds address 402 of session management node 114b in data traffic 212. In some examples, the embedded address 402 is encrypted by operation 342. Network bridge 200a forwards data traffic 212 to charging node 115b in operation 344 (based on at least data traffic 212 being associated with traffic class 222), by replacing the “to” address, originally address 403 of network bridge 200a, with address 405 of charging node 115b in data traffic 212, in operation 346. Additionally, the “from” address is replaced with address 403 of network bridge 200a, along with the encrypted version of address 402 (as described above).

Charging node 115b processes data traffic 212 in operation 348, such as charging for and enforcing traffic policies for data traffic 212, as well as performing traffic diagnostics for data traffic 212. Charging node 115b responds to data traffic 212 with a response 422, which is received by network bridge 200a in operation 350. Response 422 is from address 405 and to address 403, along with the encrypted version of address 402. In operation 352, network bridge 200a extracts address 402 from response 422, which includes decrypting address 402 in operation 354. This is also shown as operation 424 in message sequence diagram 400b. Network bridge 200a forwards response 422 to session management node 114b using the (decrypted) extracted address 402 in operation 356, which includes replacing address 403 with address 402 in response 422, during operation 358. Additionally, the “from” address is changed from address 405 to address 403.

For completeness, two more passes through flowchart 300 are described: one in which data traffic 213, which is associated with traffic class 221, is received from session management node 114b, and another in which data traffic 214, which is associated with traffic class 222, is received from session management node 114a.

This third described pass through flowchart 300 commences with network bridge 200a receiving data traffic 213 from session management node 114b in operation 302. Decision operation 304 determines whether the data traffic received in operation 302 is associated with traffic class 221 or traffic class 222. Decision operation 304 determines that data traffic 213 is associated with traffic class 221, because data traffic 213 is associated with DNN 224a (i.e., contains DNN 224a). This branch and pass through flowchart 300 is associated with message sequence diagram 400c. Data traffic 211 is shown in message sequence diagram 400c of FIG. 4C as going from session management node 114b to network bridge 200a, and so has a packet header “from” field populated with an address 402 of session management node 114b, a “to” field populated with an address 403 of network bridge 200a, and DNN 224a somewhere within the content of data traffic 213.

In operation 310 of flowchart 300 (of FIG. 3), also shown as operation 430 in message sequence diagram 400c (of FIG. 4C), network bridge 200a embeds address 402 of session management node 114b in data traffic 213. In some examples, the embedded address 402 is encrypted by operation 312. Network bridge 200a forwards data traffic 213 to charging node 115a in operation 314 (based on at least data traffic 213 being associated with traffic class 221), by replacing the “to” address, originally address 403 of network bridge 200a, with address 404 of charging node 115a in data traffic 213, in operation 316. Additionally, the “from” address is replaced with address 403 of network bridge 200a, along with the encrypted version of address 402 (as described above). Charging node 115a processes data traffic 213 in operation 318, such as charging for and enforcing traffic policies for data traffic 213.

Charging node 115a responds to data traffic 213 with a response 432, which is received by network bridge 200a in operation 320. Response 432 is from address 404 and to address 403, along with the encrypted version of address 402. In operation 322, network bridge 200a extracts address 402 from response 432, which includes decrypting address 402 in operation 324. This is also shown as operation 434 in message sequence diagram 400c.

Network bridge 200a forwards response 432 to session management node 114b using the (decrypted) extracted address 402 in operation 326, which includes replacing address 403 with address 402 in response 432, during operation 328. Additionally, the “from” address is changed from address 404 to address 403. In operation 330, network bridge 200a also forwards data traffic 213 to charging node 115b (for possible troubleshooting purposes), based on at least receiving response 432, in operation 332. This requires replacing address 403 with address 405 of charging node 115b in the version of data traffic 213 that was received from session management node 114b. An equivalent operation is replacing address 404 with address 405 in the version of data traffic 213 that was forwarded to charging node 115a.

In operation 334, charging node 115b processes data traffic 213, such as performing traffic diagnostics for data traffic 213. Charging node 115b responds to data traffic 213 with a response 436, which is received by network bridge 200a in operation 336. However, because session management node 114b is operating in a legacy manner and is expecting to be communicating with only a single charging node, response 416 is not forwarded to session management node 114b. Session management node 114b already received response 432.

The final pass through flowchart 300 commences with network bridge 200a receiving data traffic 214 from session management node 114a in operation 302. In this pass through flowchart 300, decision operation 304 determines that data traffic 214 is associated with traffic class 222, because data traffic 214 is associated with DNN 224b (i.e., contains DNN 224b). This branch and pass through flowchart 300 is associated with message sequence diagram 400d. Data traffic 214 is shown in message sequence diagram 400d of FIG. 4D as going from session management node 114a to network bridge 200a, and so has a packet header “from” field populated with an address 401 of session management node 114a, a “to” field populated with an address 403 of network bridge 200a, and DNN 224b somewhere within the content of data traffic 214.

In operation 340 of flowchart 300 (of FIG. 3), also shown as operation 440 in message sequence diagram 400d (of FIG. 4B), network bridge 200a embeds address 401 of session management node 114a in data traffic 214. In some examples, the embedded address 401 is encrypted by operation 342. Network bridge 200a forwards data traffic 214 to charging node 115b in operation 344 (based on at least data traffic 214 being associated with traffic class 222), by replacing the “to” address, originally address 403 of network bridge 200a, with address 405 of charging node 115b in data traffic 214, in operation 346. Additionally, the “from” address is replaced with address 403 of network bridge 200a, along with the encrypted version of address 401 (as described above).

Charging node 115b processes data traffic 214 in operation 348, such as charging for and enforcing traffic policies for data traffic 214, as well as performing traffic diagnostics for data traffic 214. Charging node 115b responds to data traffic 214 with a response 442, which is received by network bridge 200a in operation 350. Response 442 is from address 405 and to address 403, along with the encrypted version of address 401. In operation 352, network bridge 200a extracts address 401 from response 422, which includes decrypting address 401 in operation 354. This is also shown as operation 444 in message sequence diagram 400d. Network bridge 200a forwards response 442 to session management node 114a using the (decrypted) extracted address 401 in operation 356, which includes replacing address 403 with address 401 in response 422, during operation 358. Additionally, the “from” address is changed from address 405 to address 403.

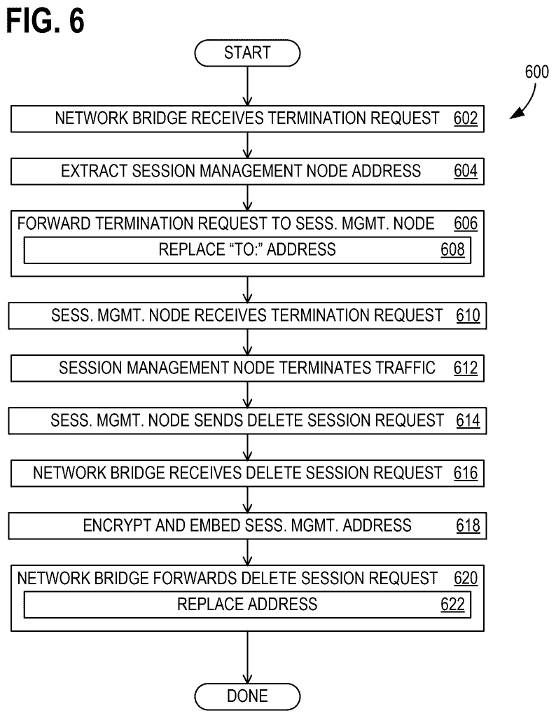

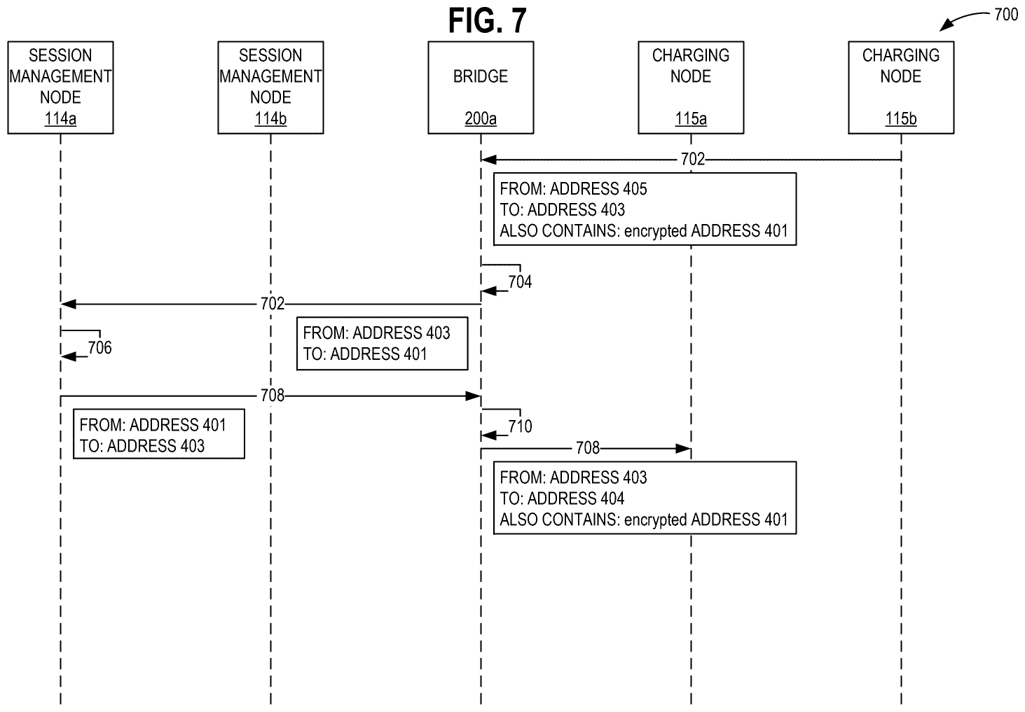

FIG. 6 illustrates a flowchart 600 of exemplary operations associated with architecture 100. In some examples, at least a portion of flowchart 600 may be performed using one or more computing devices 1100 of FIG. 11. FIG. 7 illustrates an exemplary message sequence diagram 700 of messages that may occur when performing the operations flowchart 600. FIGS. 6 and 7 are described together.

Flowchart 600 commences with network bridge 200a receiving a terminate action request 702 from charging node 115b in operation 602. This is also shown in message sequence diagram 700, with terminate action request 702 having a “To:” address of address 403 and a “from:” address as address 405. Terminate action request 702 also carries an encrypted version of address 401 from prior communication with network bridge 200a. In operation 604 network bridge 200a extracts and decrypts address 401 of session management node 114a from terminate action request 702. This is also shown as operation 704 in message sequence diagram 700. Network bridge 200a forwards terminate action request 702 to session management node 114a in operation 606, which includes replacing address 403 of network bridge 200a with address 401 of session management node 114a in terminate action request 702, during operation 608.

Session management node 114a receives terminate action request 702 in operation 610, and terminates the identified date traffic session(s) (i.e., identified in terminate action request 702) in operation 612. This is also shown as operation 706 in message sequence diagram 700. Session management node 114a transmits a delete session request 708 to network bridge 200a in operation 614. This is also shown in message sequence diagram 700, with delete session request 708 having a “To:” address of address 403 and a “from:” address as address 401. Network bridge 200a receives delete session request 708 from session management node 114a in operation 616.

In operation 618, network bridge 200a, encrypts and embeds address 401 of session management node 114a in delete session request 708, which is also shown as operation 710 in message sequence diagram 700. Network bridge 200a forwards delete session request 708 to charging node 115a in operation 620, which includes replacing address 403 of network bridge 200a with address 404 of charging node 115a in delete session request 708, during operation 622.

FIG. 8 shows an exemplary excerpt 800 of delete session request 708. Excerpt 800 contains DNN 224a, which identified data network 124a, and also a charging identifier (ID) 802 that identifies the data traffic session being terminated.

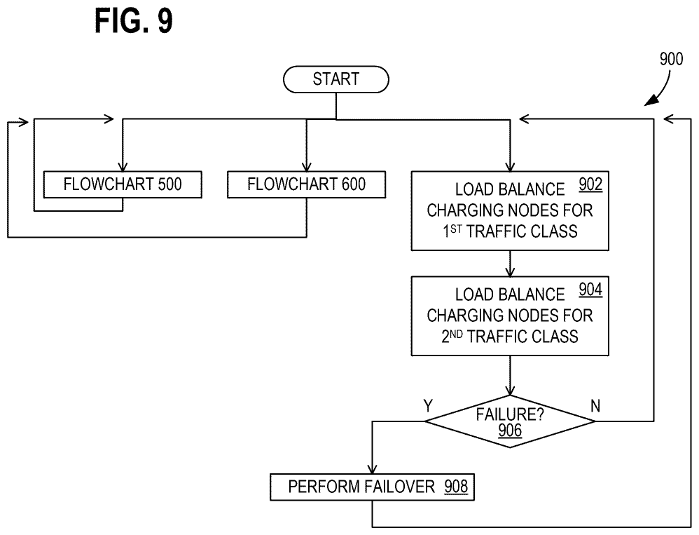

FIG. 9 illustrates a flowchart 900 of exemplary operations associated with architecture 100. In some examples, at least a portion of flowchart 900 may be performed using one or more computing devices 1100 of FIG. 11. Flowchart 900 commences with flowchart 300 and flowchart 600 operating in parallel with operations 902-908.

Operation 902 performs load balancing for data traffic associated with traffic class 221 among plurality of charging nodes 215 that are operative to charge for and enforce traffic policies for traffic class 221. Operation 904 performs load balancing for data traffic associated with traffic class 222 among plurality of charging nodes 216 that are operative to charge for and enforce traffic policies for traffic class 222 and to perform traffic diagnostics for both traffic class 221 and traffic class 221.

Decision operation 906 determines whether network bridge 200a has experienced a failure requiring a failover to network bridge 200b. If so, in operation 908, a failover is performed to network bridge 200b, which is operative to route data of traffic class 221 and data of traffic class 222 effectively the same as does network bridge 200a. Flowchart 900 continues on, in a looping manner.

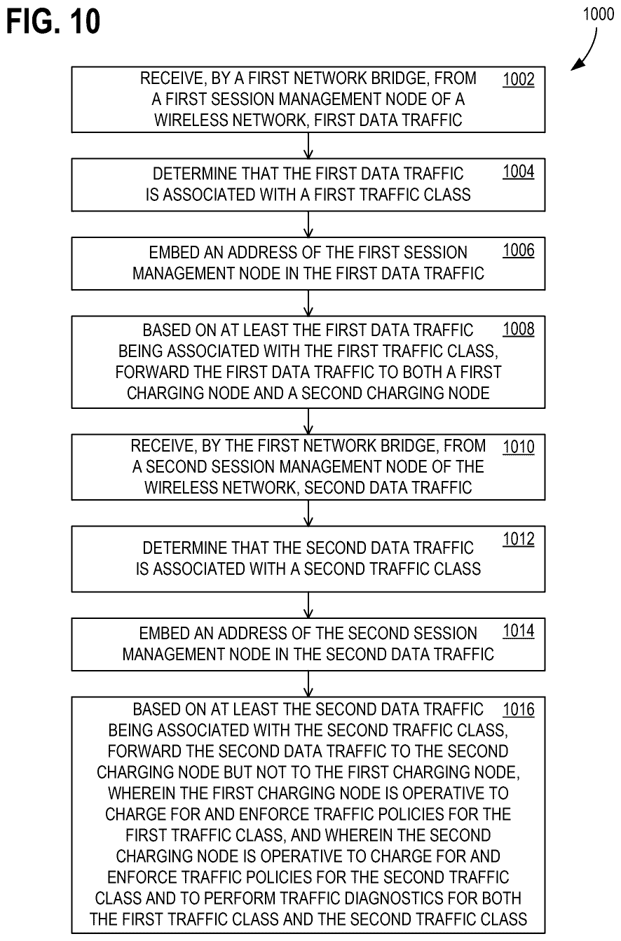

FIG. 10 illustrates a flowchart 1000 of exemplary operations associated with examples of architecture 100. In some examples, at least a portion of flowchart 1000 may be performed using one or more computing devices 1100 of FIG. 11. Flowchart 1000 commences with operation 1002, which includes receiving, by a first network bridge, from a first session management node of a wireless network, first data traffic.

Operation 1004 includes determining that the first data traffic is associated with a first traffic class. Operation 1006 includes embedding an address of the first session management node in the first data traffic. Operation 1008 includes based on at least the first data traffic being associated with the first traffic class, forwarding the first data traffic to both a first charging node and a second charging node. Operation 1010 includes receiving, by the first network bridge, from a second session management node of the wireless network, second data traffic;

Operation 1012 includes determining that the second data traffic is associated with a second traffic class. Operation 1014 includes embedding an address of the second session management node in the second data traffic. Operation 1016 includes, based on at least the second data traffic being associated with the second traffic class, forwarding the second data traffic to the second charging node but not to the first charging node, wherein the first charging node is operative to charge for and enforce traffic policies for the first traffic class, and wherein the second charging node is operative to charge for and enforce traffic policies for the second traffic class and to perform traffic diagnostics for both the first traffic class and the second traffic class.

FIG. 11 illustrates a block diagram of computing device 1100 that may be used as any component described herein that may require computational or storage capacity. Computing device 1100 has at least a processor 1102 and a memory 1104 that holds program code 1110, data area 1120, and other logic and storage 1130. Memory 1104 is any device allowing information, such as computer executable instructions and/or other data, to be stored and retrieved. For example, memory 1104 may include one or more random access memory (RAM) modules, flash memory modules, hard disks, solid-state disks, persistent memory devices, and/or optical disks. Program code 1110 comprises computer executable instructions and computer executable components including instructions used to perform operations described herein. Data area 1120 holds data used to perform operations described herein. Memory 1104 also includes other logic and storage 1130 that performs or facilitates other functions disclosed herein or otherwise required of computing device 1100. An input/output (I/O) component 1140 facilitates receiving input from users and other devices and generating displays for users and outputs for other devices. A network interface 1150 permits communication over external network 1160 with a remote node 1170, which may represent another implementation of computing device 1100. For example, a remote node 1170 may represent another of the above-noted nodes within architecture 100.

### Additional Examples

An example system comprises: a processor; and a computer-readable medium storing instructions that are operative upon execution by the processor to: receive, by a first network bridge, from a first session management node of a wireless network, first data traffic; determine that the first data traffic is associated with a first traffic class; embed an address of the first session management node in the first data traffic; based on at least the first data traffic being associated with the first traffic class, forward the first data traffic to both a first charging node and a second charging node; receive, by the first network bridge, from a second session management node of the wireless network, second data traffic; determine that the second data traffic is associated with a second traffic class; embed an address of the second session management node in the second data traffic; and based on at least the second data traffic being associated with the second traffic class, forward the second data traffic to the second charging node but not to the first charging node, wherein the first charging node is operative to charge for and enforce traffic policies for the first traffic class, and wherein the second charging node is operative to charge for and enforce traffic policies for the second traffic class and to perform traffic diagnostics for both the first traffic class and the second traffic class.

An example method of wireless communication comprises: receiving, by a first network bridge, from a first session management node of a wireless network, first data traffic; determining that the first data traffic is associated with a first traffic class; embedding an address of the first session management node in the first data traffic; based on at least the first data traffic being associated with the first traffic class, forwarding the first data traffic to both a first charging node and a second charging node; receiving, by the first network bridge, from a second session management node of the wireless network, second data traffic; determining that the second data traffic is associated with a second traffic class; embedding an address of the second session management node in the second data traffic; and based on at least the second data traffic being associated with the second traffic class, forwarding the second data traffic to the second charging node but not to the first charging node, wherein the first charging node is operative to charge for and enforce traffic policies for the first traffic class, and wherein the second charging node is operative to charge for and enforce traffic policies for the second traffic class and to perform traffic diagnostics for both the first traffic class and the second traffic class.

One or more example computer storage devices has computer-executable instructions stored thereon, which, upon execution by a computer, cause the computer to perform operations comprising: receiving, by a first network bridge, from a first session management node of a wireless network, first data traffic; determining that the first data traffic is associated with a first traffic class; embedding an address of the first session management node in the first data traffic; based on at least the first data traffic being associated with the first traffic class, forwarding the first data traffic to both a first charging node and a second charging node; receiving, by the first network bridge, from a second session management node of the wireless network, second data traffic; determining that the second data traffic is associated with a second traffic class; embedding an address of the second session management node in the second data traffic; and based on at least the second data traffic being associated with the second traffic class, forwarding the second data traffic to the second charging node but not to the first charging node, wherein the first charging node is operative to charge for and enforce traffic policies for the first traffic class, and wherein the second charging node is operative to charge for and enforce traffic policies for the second traffic class and to perform traffic diagnostics for both the first traffic class and the second traffic class.

Alternatively, or in addition to the other examples described herein, examples include any combination of the following:
determining that the first data traffic is associated with the first traffic class comprises determining that the first data traffic is associated with a first DNN;
determining that the second data traffic is associated with the second traffic class comprises determining that the second data traffic is associated with a second DNN different than the first DNN;
receiving, by the first network bridge, from the first charging node, a first response to the first data traffic;
extracting, from the first response, the address of the first session management node;
forwarding, by the first network bridge, the first response to the first session management node using the extracted address of the first session management node;
forwarding the first data traffic to the second charging node is based on at least receiving the first response;
receiving, by the first network bridge, from the second charging node, a second response to the second data traffic;
extracting, from the second response, the address of the second session management node;
forwarding, by the first network bridge, the second response to the second session management node using the extracted address of the second session management node;
decrypting the extracted address of the first session management node;
embedding the address of the first session management node comprises encrypting the address of the first session management node;
embedding the address of the first session management node comprises embedding the encrypted address of the first session management node;
decrypting the extracted address of the second session management node;
embedding the address of the second session management node comprises encrypting the address of the second session management node;
embedding the address of the second session management node comprises embedding the encrypted address of the second session management node;
receiving, by the first network bridge, from the second charging node, a terminate action request;
forwarding, by the first network bridge, to the first session management node, the terminate action request;
receiving, by the first network bridge, from the first session management node, a delete session request;
forwarding, by the first network bridge, to the first charging node, the delete session request;
receiving, from the second session management node, by the first network bridge, third data traffic;
determining that the third data traffic is associated with the first traffic class;
embedding the address of the second session management node in the third data traffic;
based on at least the third data traffic being associated with the first traffic class, forwarding the third data traffic to both the first charging node and the second charging node;
receiving, from the first session management node, by the first network bridge, fourth data traffic;
determining that the fourth data traffic is associated with the second traffic class;
embedding an address of the first session management node in the fourth data traffic;
based on at least the fourth data traffic being associated with the second traffic class, forwarding the second data traffic to the second charging node but not to the first charging node;
performing load balancing for data traffic associated with the first traffic class among a first plurality of charging nodes that are operative to charge for and enforce traffic policies for the first traffic class;
the first plurality of charging nodes includes the first charging node;
performing load balancing for data traffic associated with the second traffic class among a second plurality of charging nodes that are operative to charge for and enforce traffic policies for the second traffic class and to perform traffic diagnostics for both the first traffic class and the first traffic class;
the second plurality of charging nodes includes the second charging node;
based on at least a failure of the first network bridge, performing a failover to a second network bridge, the second network bridge operative to route data of the first traffic class and data of the second traffic class as the first network bridge;
the wireless network comprises a cellular network;
the first session management node and the second session management node each comprises an SMF or an SAEGW-C;
the first charging node and the second charging node each comprises a CHF or an OCS;
enforcing traffic policies comprises throttling or capping traffic flow;
the first traffic class comprises a B2C traffic class;
the second traffic class comprises a B2B traffic class;
the first charging node comprises a B2C charging node;
the second charging node comprises a B2B charging node;
receiving, by the first network bridge, from the second charging node, a third response to the first data traffic;
not forwarding the third response;
forwarding data traffic and terminate action requests, by the first network bridge, to the first session management node, comprises replacing, in the data traffic and terminate action requests, an address of the first network bridge with the address of the first session management node;
forwarding data traffic and terminate action requests, by the first network bridge, to the second session management node, comprises replacing, in the data traffic and terminate action requests, the address of the first network bridge with the address of the second session management node;
forwarding data traffic and delete session requests, by the first network bridge, to the first charging node, comprises replacing, in the data traffic and delete session requests, the address of the first network bridge with the address of the first charging node;
forwarding data traffic, by the first network bridge, to the second charging node, comprises replacing, in the data traffic, the address of the first network bridge with the address of the second charging node;
receiving, by the first session management node, from the first network bridge, the terminate action request;
terminating, by the first session management node, data traffic sessions associated with the first DNN and the second DNN; and
transmitting, by the first session management node, to the first network bridge, the delete session request.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of wireless communication, the method comprising:
receiving, by a first network bridge, from a first session management node of a wireless network, first data traffic;
determining that the first data traffic is associated with a first traffic class;
embedding an address of the first session management node in the first data traffic;
based on at least the first data traffic being associated with the first traffic class, forwarding the first data traffic to both a first charging node and a second charging node;
receiving, by the first network bridge, from a second session management node of the wireless network, second data traffic;
determining that the second data traffic is associated with a second traffic class;
embedding an address of the second session management node in the second data traffic; and
based on at least the second data traffic being associated with the second traffic class, forwarding the second data traffic to the second charging node but not to the first charging node, wherein the first charging node is operative to charge for and enforce traffic policies for the first traffic class, and wherein the second charging node is operative to charge for and enforce traffic policies for the second traffic class and to perform traffic diagnostics for both the first traffic class and the second traffic class.

2. The method of claim 1,
wherein determining that the first data traffic is associated with the first traffic class comprises determining that the first data traffic is associated with a first data network name (DNN); and
wherein determining that the second data traffic is associated with the second traffic class comprises determining that the second data traffic is associated with a second DNN different than the first DNN.

3. The method of claim 1, further comprising:
receiving, by the first network bridge, from the first charging node, a first response to the first data traffic;
extracting, from the first response, the address of the first session management node;
forwarding, by the first network bridge, the first response to the first session management node using the extracted address of the first session management node, wherein forwarding the first data traffic to the second charging node is based on at least receiving the first response;
receiving, by the first network bridge, from the second charging node, a second response to the second data traffic;
extracting, from the second response, the address of the second session management node; and
forwarding, by the first network bridge, the second response to the second session management node using the extracted address of the second session management node.

4. The method of claim 3, further comprising:
decrypting the extracted address of the first session management node, wherein embedding the address of the first session management node comprises:
encrypting the address of the first session management node; and
embedding the encrypted address of the first session management node; and
decrypting the extracted address of the second session management node, wherein embedding the address of the second session management node comprises:
encrypting the address of the second session management node; and
embedding the encrypted address of the second session management node.

5. The method of claim 1, further comprising:
receiving, by the first network bridge, from the second charging node, a terminate action request;
forwarding, by the first network bridge, to the first session management node, the terminate action request;
receiving, by the first network bridge, from the first session management node, a delete session request; and
forwarding, by the first network bridge, to the first charging node, the delete session request.

6. The method of claim 1, further comprising:
receiving, from the second session management node, by the first network bridge, third data traffic;
determining that the third data traffic is associated with the first traffic class;
embedding the address of the second session management node in the third data traffic;
based on at least the third data traffic being associated with the first traffic class, forwarding the third data traffic to both the first charging node and the second charging node;
receiving, from the first session management node, by the first network bridge, fourth data traffic;
determining that the fourth data traffic is associated with the second traffic class;
embedding an address of the first session management node in the fourth data traffic; and
based on at least the fourth data traffic being associated with the second traffic class, forwarding the second data traffic to the second charging node but not to the first charging node.

7. The method of claim 1, further comprising:
performing load balancing for data traffic associated with the first traffic class among a first plurality of charging nodes that are operative to charge for and enforce traffic policies for the first traffic class, the first plurality of charging nodes including the first charging node;
performing load balancing for data traffic associated with the second traffic class among a second plurality of charging nodes that are operative to charge for and enforce traffic policies for the second traffic class and to perform traffic diagnostics for both the first traffic class and the first traffic class, the second plurality of charging nodes including the second charging node; and
based on at least a failure of the first network bridge, performing a failover to a second network bridge, the second network bridge operative to route data of the first traffic class and data of the second traffic class as the first network bridge.

8. A system comprising:
a processor; and
a computer-readable medium storing instructions that are operative upon execution by the processor to:
receive, by a first network bridge, from a first session management node of a wireless network, first data traffic;
determine that the first data traffic is associated with a first traffic class;
embed an address of the first session management node in the first data traffic;
based on at least the first data traffic being associated with the first traffic class, forward the first data traffic to both a first charging node and a second charging node;
receive, by the first network bridge, from a second session management node of the wireless network, second data traffic;
determine that the second data traffic is associated with a second traffic class;
embed an address of the second session management node in the second data traffic; and
based on at least the second data traffic being associated with the second traffic class, forward the second data traffic to the second charging node but not to the first charging node, wherein the first charging node is operative to charge for and enforce traffic policies for the first traffic class, and wherein the second charging node is operative to charge for and enforce traffic policies for the second traffic class and to perform traffic diagnostics for both the first traffic class and the second traffic class.

9. The system of claim 8,
wherein determining that the first data traffic is associated with the first traffic class comprises determining that the first data traffic is associated with a first data network name (DNN); and
wherein determining that the second data traffic is associated with the second traffic class comprises determining that the second data traffic is associated with a second DNN different than the first DNN.

10. The system of claim 8, wherein the instructions are further operative to:
receive, by the first network bridge, from the first charging node, a first response to the first data traffic;
extract, from the first response, the address of the first session management node;
forward, by the first network bridge, the first response to the first session management node using the extracted address of the first session management node, wherein forwarding the first data traffic to the second charging node is based on at least receiving the first response;
receive, by the first network bridge, from the second charging node, a second response to the second data traffic;
extract, from the second response, the address of the second session management node; and
forward, by the first network bridge, the second response to the second session management node using the extracted address of the second session management node.

11. The system of claim 10, wherein the instructions are further operative to:
decrypt the extracted address of the first session management node, wherein embedding the address of the first session management node comprises:
encrypting the address of the first session management node; and
embedding the encrypted address of the first session management node; and
decrypt the extracted address of the second session management node, wherein embedding the address of the second session management node comprises:
encrypting the address of the second session management node; and
embedding the encrypted address of the second session management node.

12. The system of claim 8, wherein the instructions are further operative to:
receive, by the first network bridge, from the second charging node, a terminate action request;
forward, by the first network bridge, to the first session management node, the terminate action request;
receive, by the first network bridge, from the first session management node, a delete session request; and
forward, by the first network bridge, to the first charging node, the delete session request.

13. The system of claim 8, wherein the instructions are further operative to:
receive, from the second session management node, by the first network bridge, third data traffic;
determine that the third data traffic is associated with the first traffic class;
embed the address of the second session management node in the third data traffic;
based on at least the third data traffic being associated with the first traffic class, forward the third data traffic to both the first charging node and the second charging node;
receive, from the first session management node, by the first network bridge, fourth data traffic;
determine that the fourth data traffic is associated with the second traffic class;
embed an address of the first session management node in the fourth data traffic; and
based on at least the fourth data traffic being associated with the second traffic class, forward the second data traffic to the second charging node but not to the first charging node.

14. The system of claim 8, wherein the instructions are further operative to:
perform load balancing for data traffic associated with the first traffic class among a first plurality of charging nodes that are operative to charge for and enforce traffic policies for the first traffic class, the first plurality of charging nodes including the first charging node;
perform load balancing for data traffic associated with the second traffic class among a second plurality of charging nodes that are operative to charge for and enforce traffic policies for the second traffic class and to perform traffic diagnostics for both the first traffic class and the first traffic class, the second plurality of charging nodes including the second charging node; and
based on at least a failure of the first network bridge, perform a failover to a second network bridge, the second network bridge operative to route data of the first traffic class and data of the second traffic class as the first network bridge.

15. One or more computer storage devices having computer-executable instructions stored thereon, which, upon execution by a computer, cause the computer to perform operations comprising:
receiving, by a first network bridge, from a first session management node of a wireless network, first data traffic;
determining that the first data traffic is associated with a first traffic class;
embedding an address of the first session management node in the first data traffic;
based on at least the first data traffic being associated with the first traffic class, forwarding the first data traffic to both a first charging node and a second charging node;
receiving, by the first network bridge, from a second session management node of the wireless network, second data traffic;
determining that the second data traffic is associated with a second traffic class;
embedding an address of the second session management node in the second data traffic; and
based on at least the second data traffic being associated with the second traffic class, forwarding the second data traffic to the second charging node but not to the first charging node, wherein the first charging node is operative to charge for and enforce traffic policies for the first traffic class, and wherein the second charging node is operative to charge for and enforce traffic policies for the second traffic class and to perform traffic diagnostics for both the first traffic class and the second traffic class.

16. The one or more computer storage devices of claim 15,
wherein determining that the first data traffic is associated with the first traffic class comprises determining that the first data traffic is associated with a first data network name (DNN); and
wherein determining that the second data traffic is associated with the second traffic class comprises determining that the second data traffic is associated with a second DNN different than the first DNN.

17. The one or more computer storage devices of claim 15, wherein the operations further comprise:
receiving, by the first network bridge, from the first charging node, a first response to the first data traffic;
extracting, from the first response, the address of the first session management node;
forwarding, by the first network bridge, the first response to the first session management node using the extracted address of the first session management node, wherein forwarding the first data traffic to the second charging node is based on at least receiving the first response;
receiving, by the first network bridge, from the second charging node, a second response to the second data traffic;
extracting, from the second response, the address of the second session management node; and
forwarding, by the first network bridge, the second response to the second session management node using the extracted address of the second session management node.

18. The one or more computer storage devices of claim 17, wherein the operations further comprise:
decrypting the extracted address of the first session management node, wherein embedding the address of the first session management node comprises:
encrypting the address of the first session management node; and
embedding the encrypted address of the first session management node; and
decrypting the extracted address of the second session management node, wherein embedding the address of the second session management node comprises:
encrypting the address of the second session management node; and
embedding the encrypted address of the second session management node.

19. The one or more computer storage devices of claim 15, wherein the operations further comprise:
receiving, by the first network bridge, from the second charging node, a terminate action request;
forwarding, by the first network bridge, to the first session management node, the terminate action request;
receiving, by the first network bridge, from the first session management node, a delete session request; and
forwarding, by the first network bridge, to the first charging node, the delete session request.

20. The one or more computer storage devices of claim 15, wherein the operations further comprise:
receiving, from the second session management node, by the first network bridge, third data traffic;
determining that the third data traffic is associated with the first traffic class;
embedding the address of the second session management node in the third data traffic;
based on at least the third data traffic being associated with the first traffic class, forwarding the third data traffic to both the first charging node and the second charging node;
receiving, from the first session management node, by the first network bridge, fourth data traffic;
determining that the fourth data traffic is associated with the second traffic class;
embedding an address of the first session management node in the fourth data traffic; and
based on at least the fourth data traffic being associated with the second traffic class, forwarding the second data traffic to the second charging node but not to the first charging node.
